(19) United States
(12) Patent Application Publication
(10) Pub. No.: US 2025/0381659 A1
(43) Pub. Date: Dec. 18, 2025

(54) SUPPORT ASSEMBLY AND WEARABLE ROBOT INCLUDING THE SAME

(71) Applicants: HYUNDAI MOTOR COMPANY, Seoul (KR); Kia Corporation, Seoul (KR)

(72) Inventors: Jong Kyu CHOI, Hwaseong-si (KR); Jong Woo KIM, Hwaseong-si (KR); Ye Young KIM, Hwaseong-si (KR); Kyu Jung KIM, Hwaseong-si (KR); Ji Hwan CHOI, Hwaseong-si (KR)

(21) Appl. No.: 18/950,704

(22) Filed: Nov. 18, 2024

(30) Foreign Application Priority Data
Jun. 17, 2024 (KR) 10-2024-0078314

(51) Int. Cl. B25J 9/00

(52) U.S. Cl. CPC B25J 9/0006

(57) ABSTRACT

A support assembly includes a supporting frame, a seating member attached to the supporting frame, and a plurality of friction pads attached to the seating member. The plurality of friction pads extend in a first direction of the seating member and are spaced apart from one another in a direction surrounding an imaginary line extending in the first direction.

### CROSS-REFERENCE TO RELATED APPLICATION

This application claims the benefit of priority to Korean Patent Application No. 10-2024-0078314, filed in the Korean Intellectual Property Office, on Jun. 17, 2024, the entire contents of which are incorporated herein by reference.

### TECHNICAL FIELD

The present disclosure relates to a support assembly and a wearable robot including the same.

### BACKGROUND

A wearable robot provides an assistant force to an upper arm of the user while being mounted on the upper body of the user. For example, the wearable robot may assist the user by providing a force for pressing the arm of the user upward.

The wearable robot may assist the user when the user performs a task in an arm raised position, for example, an assembly operation under a vehicle. In some cases, the wearable robot may include a support assembly that supports the arm of the user.

In some cases, where the user performs a task with the arm of the user supported by the support assembly, the arm of the user may slip from the support assembly. In this case, the operation of the user may not be easy, and a wearable robot that may assist the arm of the user to move relatively freely may be helpful.

### SUMMARY

The present disclosure describes a support assembly that prevents an elbow of a user from slipping while the arm of the user is freely moved inward, and a wearable robot including the same.

According to one aspect of subject matter described in the present disclosure, a support assembly includes a supporting frame, a seating member attached to the supporting frame, and a plurality of friction pads attached to the seating member, each of the plurality of friction pads extending in a first direction, where plurality of friction pads are spaced apart from one other in a circumferential direction that surrounds an axis extending in the first direction.

Implementations according to this aspect can include one or more of the following features. For example, the seating member may have (i) a first side facing the supporting frame and (ii) a second side opposite to the first side, where the seating member defines a recessed area that is recessed from the second side of the seating member and extends in the first direction.

In some implementations, a first deformation ratio defined by a first deformation amount to a specific external force applied to the seating member in the first direction is less than a second deformation ratio defined by a second deformation amount to a specific external force applied to the seating member in the circumferential direction.

In some implementations, the recessed area is one of a plurality of recessed areas that are recessed from the second side of the seating member and spaced apart from one another in the circumferential direction. In some examples, the recessed area is defined between adjacent friction pads of the plurality of friction pads.

In some implementations, the seating member may include a plurality of seating areas arranged along the circumferential direction. Each of the plurality of seating areas may include a first end disposed at the first side of the seating member and attached to the supporting frame in a second direction crossing the first direction, and a second end disposed at the second side of the seating member and separated from another adjacent seating area of the plurality of seating areas by one of the plurality of recessed areas. The second ends of the plurality of seating areas are arranged alternately with one of the plurality of recessed areas therebetween.

In some implementations, the recessed area extends to the supporting frame in a second direction crossing the first direction. In some examples, the recessed area is spaced apart from the supporting frame in the second direction crossing the first direction.

In some implementations, the seating member may include an expansion/contraction area that is made of a stretchable material, each of the plurality of friction pads is attached to the expansion/contraction area. In some examples, the seating member may include an air mesh area made of an air permeable material and disposed at a first side of the expansion/contraction area in a second direction crossing the first direction, and an impact absorption area made of an elastic material and disposed between the air mesh area and the supporting frame.

In some implementations, the supporting frame extends in the circumferential direction and surrounds the axis. In some examples, each of the plurality of friction pads may include a silicon tape.

According to another aspect, a wearable robot is configured to assist a task of a user. The wearable robot includes a connecting frame that extends in a first direction, and a support assembly that is connected to the connecting frame and surrounds an axis extending parallel to the first direction. The support assembly includes a supporting frame that extends in a circumferential direction surrounding the axis, a seating member that is supported by the supporting frame, the seating member having (i) a first side facing the supporting frame and (ii) a second side opposite to the first side, where the seating member defines a recessed area that is recessed from the second side of the seating member and extends in the first direction, and a friction pad attached to the seating member.

Implementations according to this aspect can include one or more of the following features. For example, the friction pad is one of a plurality of friction pads that are spaced apart from one another in the circumferential direction, each of the plurality of friction pads extending in the first direction. In some examples, the recessed area is one of a plurality of recessed areas that are defined at the second sided of the seating member, where the plurality of seating areas are arranged alternately with one of the plurality of recessed areas therebetween.

In some implementations, a first deformation ratio defined by a first deformation amount to a specific external force applied to the seating member in the first direction is less than a second deformation ratio defined by a second deformation amount to a specific external force applied to the seating member in the circumferential direction.

In some implementations, the seating member may include a plurality of seating areas arranged along the circumferential direction, where each of the plurality of seating areas may include a first end disposed at the first side of the seating member and attached to the supporting frame in a second direction crossing the first direction, and a second end disposed at the second side of the seating member and separated from another adjacent seating area by the recessed area.

In some examples, the seating member may include an expansion/contraction area made a stretchable material, wherein the friction pad is attached to the expansion/contraction area, an air mesh area made of an air permeable material and disposed at a first side of the expansion/contraction area in a second direction crossing the first direction, and an impact absorption area made of an elastic material and disposed between the air mesh area and the supporting frame.

### BRIEF DESCRIPTION OF THE DRAWINGS

The above and other objects, features and advantages of the present disclosure will be more apparent from the following detailed description taken in conjunction with the accompanying drawings.

FIG. 1 is a view illustrating an example in which a user wears a wearable robot.

FIG. 2 is a front view illustrating an example of a wearable robot.

FIG. 3 is a schematic view illustrating an example state before a support assembly is bent.

FIG. 4 is a schematic view illustrating an example of a vertical cross section of a support assembly.

FIG. 5 is a vertical cross-sectional view illustrating an example of a support assembly.

FIG. 6 is an enlarged view of a dotted line portion illustrated in FIG. 5.

FIG. 7 is a cross-sectional view illustrating an example of a layered structure of a seating member.

FIG. 8 is a vertical cross-sectional view illustrating an example of a support assembly.

### DETAILED DESCRIPTION

Hereinafter, the present disclosure will be described in detail with reference to the accompanying drawings. In adding reference numerals to the components of the drawings, it is noted that the same components are denoted by the same reference numerals even when they are drawn in different drawings.

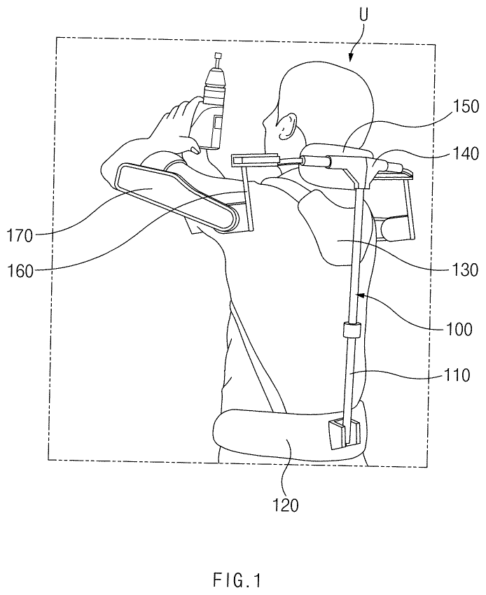

Hereinafter, one or more implementations of the present disclosure will be described in detail with reference to FIGS. 1 to 8.

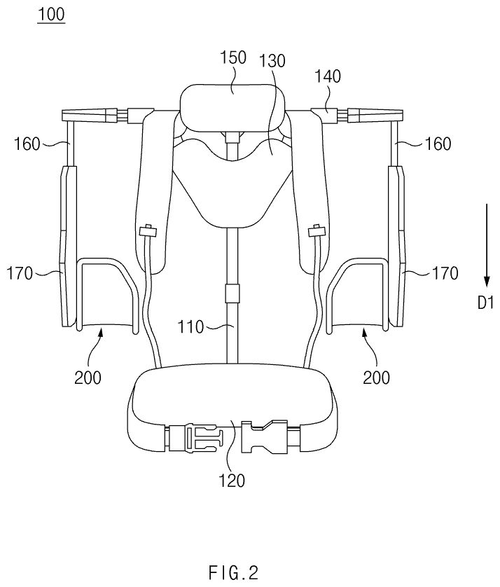

FIG. 1 is a view illustrating an example state, in which a user wears a wearable robot. FIG. 2 is a front view showing an example of a wearable robot.

Referring to FIGS. 1 and 2, a wearable robot 100 may be mounted by user U to assist a task of the user U. The wearable robot 100 may support an upper body of the user U to provide an assistant force to an upper arm of the user U. Hereinafter, the wearable robot 100 will be described with reference to a state, in which the user U wears the wearable robot 100.

The wearable robot 100 may include a center link 110 that extends in a height direction behind the user U, a lower band 120 that is connected to a lower portion of the center link 110, and a backrest pad 130 that is provided on an upper side of the lower band 120 and is coupled to the center link 110. The wearable robot 100 may include an upper link 140 that is connected to an upper portion of the center link 110 from an upper side of the backrest pad 130. Furthermore, the wearable robot 100 may include a head support pad 150 that is coupled to the upper link 140.

The center link 110 may extend in a height direction of the user U to constitute a frame of the wearable robot 100. The lower band 120 may extend to surround the abdomen of the user U and may support the abdomen of the user U. The backrest pad 130 may support the back of the user U from an upper side of the lower band 120. The upper link 140 may be connected to an upper portion of the center link 110 and may extend to surround the user U behind the user U. The upper link 140 may be provided on an upper side of a shoulder of the user U. The head support pad 150 may support the head of the user U.

The wearable robot 100 may include a connection link 160 that is connected to opposite sides of the upper link 140 and extends from the upper link 140 in a first direction D1. For example, the first direction D1 may be a downward direction.

The wearable robot 100 may include a connecting frame 170 that is coupled to the connection link 160 to support the brachial muscles of the user U. The wearable robot 100 may include a support assembly 200 that is connected to the connecting frame 170 to support an elbow of the user U. The support assembly 200 may have a shape that is bent to surround the elbow of the user U while being connected to the connecting frame 170.

Hereinafter, a detailed structure of the support assembly 200 will be described.

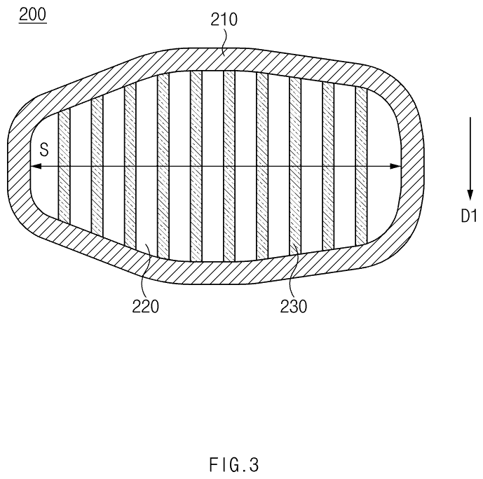

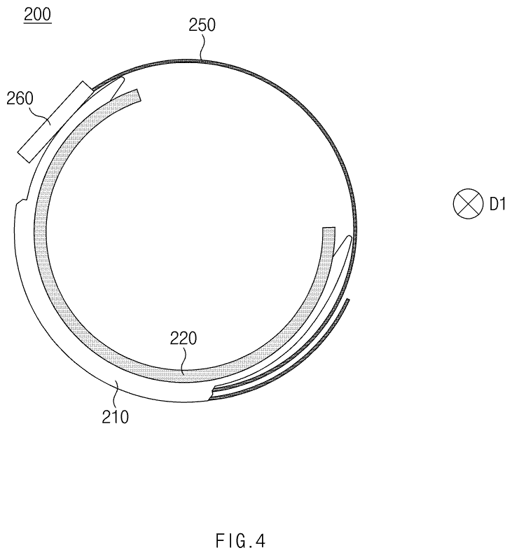

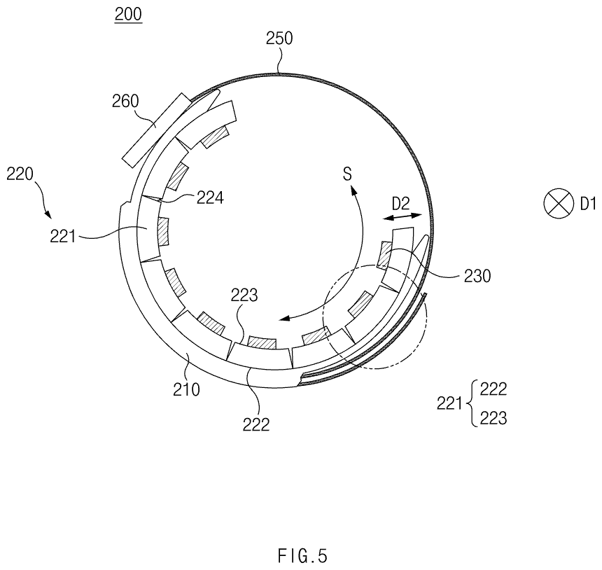

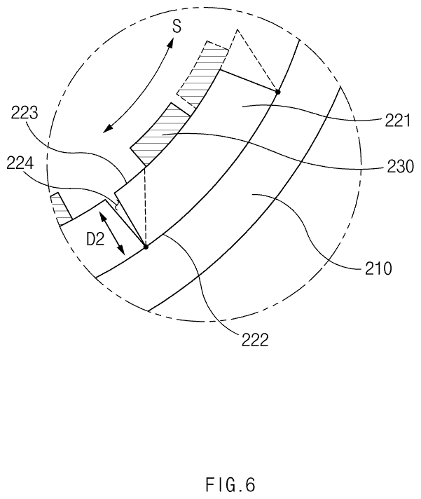

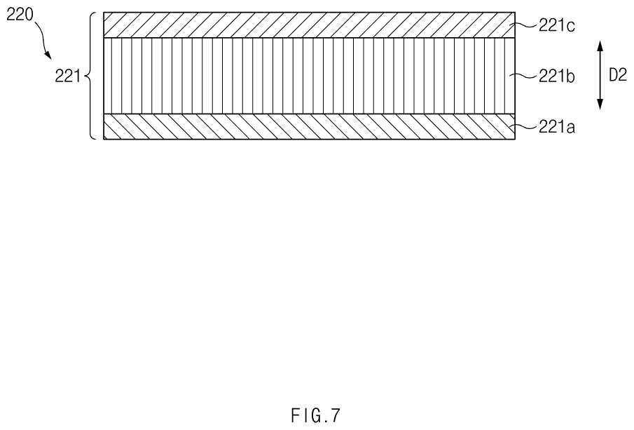

FIG. 3 is a schematic view illustrating a state before a support assembly is bent. FIG. 4 is a schematic view illustrating a vertical cross section of a support assembly. FIG. 5 is a vertical cross-sectional view of a support assembly. FIG. 6 is an enlarged view of a dotted line portion illustrated in FIG. 5. FIG. 7 is a cross-sectional view illustrating a layered structure of a seating member.

Referring to FIGS. 3 to 7, a support assembly 200 may be connected to a connecting frame 170 (see FIG. 2) to surround an axis (imaginary line) that extends parallel to the first direction D1. The support assembly 200 may include a supporting frame 210, a seating member 220 that is attached onto the supporting frame 210, and a friction pad 230 that is attached to the seating member 220.

The support assembly 200 may include a fixing band 250 for fixing the elbow of the user U (see FIG. 1), and a fixing block 260 for fixing the fixing band 250.

The supporting frame 210 may be bent in direction S, in which the imaginary line that extends along the first direction D1 is surrounded. In other words, the supporting frame 210 may extend to surround the imaginary line that extends in the first direction D1. The supporting frame 210 a may include circumferential area, and an inner area that is surrounded by the circumferential area. The inner area of the supporting frame 210 may be an area, in which the elbow of the user U is supported.

The seating member 220 may be attached to an inner area of the supporting frame 210 and be supported by the supporting frame 210. The seating member 220 may be attached to one side of the supporting frame 210, which faces the elbow of the user U, on the supporting frame 210. The seating member 220 may be provided to be stretchable.

A friction pad 230 may be attached to one side of the seating member 220, which faces the elbow of the user U. The friction pad 230 may include a silicone tape or the like to prevent the elbow of the user U from slipping.

A plurality of friction pads 230 may be provided to extend in the first direction D1 of the seating member 220 and be spaced apart from each other in an expansion/contraction direction S that is a direction, in which an imaginary line that extends in the first direction D1 of the seating member 220 is surrounded. The direction S may define a circumferential direction of the seating member 220. Each friction pad 230 may extend in the first direction D1 with a specific width in the expansion/contraction direction S. For instance, the specific width of each friction pad 230 may be less than a curve length of each seating area 221 in the direction S.

In some examples, a first value that a ratio of a deformation amount to a specific external force that is applied to the support assembly 200 in the first direction D1 may be configured to be smaller than a second value that is a ratio of a deformation amount to a specific external force that is applied to the expansion/contraction direction S.

In other words, the support assembly 200 may have a relatively small deformation amount for the external force in the first direction D1, and may have a relatively large deformation amount for the external force in the expansion/contraction direction S.

Because the supporting frame 210 is bent along the expansion/contraction direction S, the support assembly 200 may also have a shape that is bent along the expansion/contraction direction S. In more detail, the seating member 220 may extend along the supporting frame 210 in the expansion/contraction direction S, and the friction pad 230 may also have a specific width that extends along the seating member 220 in the expansion/contraction direction S.

In some implementations, the seating member 220 may include a recessed area 224 that is recessed from an opposite side to one side that faces the supporting frame 210 and extends in the first direction D1. A plurality of recessed areas 224 may be provided to be spaced apart from each other in the expansion/contraction direction S. The recessed area 224 of the seating member 220 described above may extend to the supporting frame 210 in a second direction D2. In some examples, the depth of the recessed area 224 may be less than or equal to the thickness of the seating area 221 in the second direction D2.

In some implementations, the seating member 220 may include a plurality of seating areas 221 that are divided by the recessed areas 224 with the plurality of recessed areas 224 interposed therebetween. The plurality of seating areas 221 may be arranged along the expansion/contraction direction S. The plurality of seating areas 221 may be provided with the plurality of friction pads 230, respectively. Then, the recessed areas 224 may be provided in areas between the adjacent friction pads 230, among the plurality of friction pads 230. The plurality of recessed areas 224 may be arranged alternately with the friction pads 230 along the expansion/contraction direction S.

Each of the plurality of seating areas 221 may include one end 222 that is attached to the supporting frame 210 on one side in a second direction D2 that is perpendicular to the first direction D1, and an opposite end 223 that is provided on an opposite side in the second direction D2. The opposite end 223 may be separated from another adjacent seating area 221 to be arranged alternately with the recessed area 224. That is, the opposite end 223 of the two adjacent seating areas 221 may be separated from each other in the expansion/contraction direction S.

According to this structure, as illustrated in FIG. 6, the seating member 220 is provided to be prolonged along the expansion/contraction direction S to facilitate an internal rotation that is a movement, in which an arm of the user U (see FIG. 1) is rotated in a direction that faces an upper body of the user U so that work convenience of the user U may be improved.

In some examples, each of the seating areas 221 of the seating member 220 may include an impact absorption area 221a, an air mesh area 221b, and an expansion/contraction area 221c, as illustrated in FIG. 7.

The impact absorption area 221a may be attached to the supporting frame 210 by a Velcro fastener. The impact absorption area 221a may be made of an elastic material. As an example, the impact absorption area 221a may be made of neoprene or a sponge to smoothly support the elbow of the user U.

The air mesh area 221b may be provided on an opposite side of the impact absorption area 221a in the second direction D2, and may be made of an air permeable material. The air mesh area 221b may be an area for evaporating sweat or moisture generated from the elbow of the user U.

The friction pad 230 may be attached to the expansion/contraction area 221c, and the expansion/contraction area 221c may be made of a stretchable material. The expansion/contraction area 221c may be made of a cold-sensitive material so that the user U feels comfortable. As an example, the expansion/contraction area 221c may be made of a cloth material having an improved flexibility.

In this way, the air mesh area 221b may be provided on one side of the expansion/contraction area 221c in the second direction D2, and the impact absorption area 221a may be provided between the air mesh area 221b and the supporting frame 210.

Each of the plurality of seating areas 221 may include an expansion/contraction area 221c, an air mesh area 221b, and an impact absorption area 221a, and the adjacent seating areas 221 may be sewn and connected to each other through the one end 222.

In some implementations, the seating member 220 may more comfortably support the elbow of the user U, so that the user U may wear the wearable robot 100 (refer to FIG. 1) for a longer time whereby a task performance of the user U may be improved.

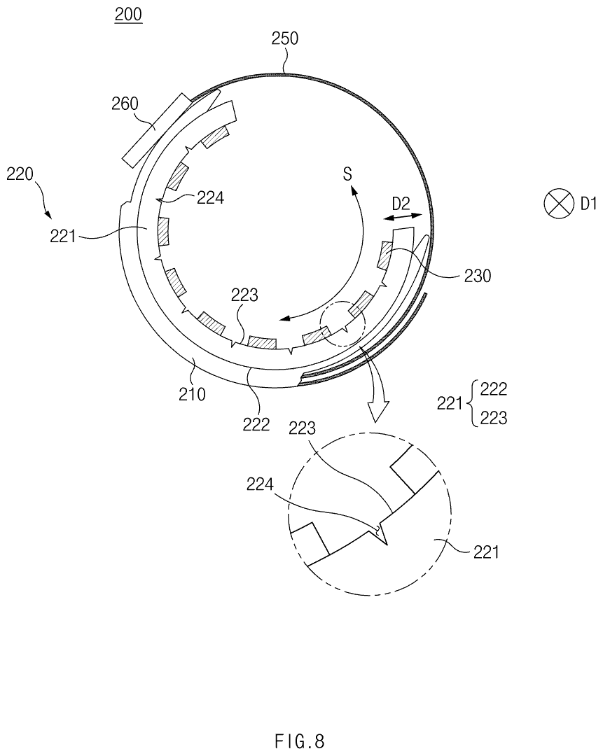

FIG. 8 is a vertical cross-sectional view illustrating an example of a support assembly.

Referring to FIG. 8, in some implementations, the recessed area 224 may be configured to be spaced apart from the supporting frame 210 in the second direction D2. In addition to the structure, a description of the impact absorption area 221a (see FIG. 7), the air mesh area 221b, the expansion/contraction area 221c, the one end 222 of the seating area 221, the opposite end 223 of the seating area 221, the supporting frame 210, the fixing band 250, and the fixing block 260 may be replaced with the description of FIG. 5.

In some implementations, the support assembly may prevent an elbow of the user from slipping when the user freely rotates the arm of the user to an inside of the user while wearing the support assembly whereby a safety of the user and convenience may be improved.

In some implementations, the support assembly may smoothly support the arm of the user, and at the same time may improve the air permeability of the support assembly, so that the satisfaction of the user may be improved.

The above description is an example description of the technical spirits of the present disclosure, and an ordinary person in the art, to which the present disclosure pertains, may make various corrections and modifications without departing from the essential characteristics of the present disclosure.

Therefore, the implementations described in the present disclosure are not for limiting the technical spirits of the present disclosure but for describing them, and the scope of the technical spirits of the present disclosure is not limited by the implementations. The protection scope of the present disclosure should be construed by the following claims, and all the technical spirits in the equivalent range should be construed as being included in the scope of the present disclosure.

What is claimed is:

1. A support assembly comprising:
a supporting frame;
a seating member attached to the supporting frame; and
a plurality of friction pads attached to the seating member, each of the plurality of friction pads extending in a first direction,
wherein plurality of friction pads are spaced apart from one other in a circumferential direction that surrounds an axis extending in the first direction.

2. The support assembly of claim 1, wherein the seating member has (i) a first side facing the supporting frame and (ii) a second side opposite to the first side, and
wherein the seating member defines a recessed area that is recessed from the second side of the seating member and extends in the first direction.

3. The support assembly of claim 1, wherein a first deformation ratio defined by a first deformation amount to a specific external force applied to the seating member in the first direction is less than a second deformation ratio defined by a second deformation amount to a specific external force applied to the seating member in the circumferential direction.

4. The support assembly of claim 2, wherein the recessed area is one of a plurality of recessed areas that are recessed from the second side of the seating member and spaced apart from one another in the circumferential direction.

5. The support assembly of claim 2, wherein the recessed area is defined between adjacent friction pads of the plurality of friction pads.

6. The support assembly of claim 4, wherein the seating member comprises a plurality of seating areas arranged along the circumferential direction,
wherein each of the plurality of seating areas comprises:
a first end disposed at the first side of the seating member and attached to the supporting frame in a second direction crossing the first direction; and
a second end disposed at the second side of the seating member and separated from another adjacent seating area of the plurality of seating areas by one of the plurality of recessed areas, and
wherein the second ends of the plurality of seating areas are arranged alternately with one of the plurality of recessed areas therebetween.

7. The support assembly of claim 2, wherein the recessed area extends to the supporting frame in a second direction crossing the first direction.

8. The support assembly of claim 2, wherein the recessed area is spaced apart from the supporting frame in a second direction crossing the first direction.

9. The support assembly of claim 1, wherein the seating member comprises an expansion/contraction area that is made of a stretchable material, and
wherein each of the plurality of friction pads is attached to the expansion/contraction area.

10. The support assembly of claim 9, wherein the seating member comprises:
an air mesh area made of an air permeable material and disposed at a first side of the expansion/contraction area in a second direction crossing the first direction; and
an impact absorption area made of an elastic material and disposed between the air mesh area and the supporting frame.

11. The support assembly of claim 1, wherein the supporting frame extends in the circumferential direction and surrounds the axis.

12. The support assembly of claim 1, wherein each of the plurality of friction pads comprises a silicon tape.

13. A wearable robot configured to assist a task of a user, the wearable robot comprising:
a connecting frame that extends in a first direction; and
a support assembly that is connected to the connecting frame and surrounds an axis extending parallel to the first direction,
wherein the support assembly comprises:
a supporting frame that extends in a circumferential direction surrounding the axis,
a seating member that is supported by the supporting frame, the seating member having (i) a first side facing the supporting frame and (ii) a second side opposite to the first side, wherein the seating member defines a recessed area that is recessed from the second side of the seating member and extends in the first direction, and
a friction pad attached to the seating member.

14. The wearable robot of claim 13, wherein the friction pad is one of a plurality of friction pads that are spaced apart from one another in the circumferential direction, each of the plurality of friction pads extending in the first direction.

15. The wearable robot of claim 14, wherein the recessed area is one of a plurality of recessed areas that are defined at the second side of the seating member, and
wherein the plurality of seating areas are arranged alternately with one of the plurality of recessed areas therebetween.

16. The wearable robot of claim 13, wherein a first deformation ratio defined by a first deformation amount to a specific external force applied to the seating member in the first direction is less than a second deformation ratio defined by a second deformation amount to a specific external force applied to the seating member in the circumferential direction.

17. The wearable robot of claim 13, wherein the seating member comprises a plurality of seating areas arranged along the circumferential direction, and
wherein each of the plurality of seating areas comprises:
a first end disposed at the first side of the seating member and attached to the supporting frame in a second direction crossing the first direction; and
a second end disposed at the second side of the seating member and separated from another adjacent seating area by the recessed area.

18. The wearable robot of claim 13, wherein the seating member comprises:
an expansion/contraction area made a stretchable material, wherein the friction pad is attached to the expansion/contraction area;
an air mesh area made of an air permeable material and disposed at a first side of the expansion/contraction area in a second direction crossing the first direction; and
an impact absorption area made of an elastic material and disposed between the air mesh area and the supporting frame.
